(19) United States
(12) Patent Application Publication
(10) Pub. No.: US 2026/0331821 A1
(43) Pub. Date: Oct. 22, 2026

(54) Cap Assembly and Flash Drive

(71) Applicants: Tekism Co., Ltd.,, Suzhou (CN); Tekism Inc., SAN FRANCISCO, CA (US)

(72) Inventors: Zhiwen PENG, Suzhou (CN); Chengjian CHAI, Suzhou (CN)

(73) Assignees: Tekism Co., Ltd.,, Suzhou (CN); Tekism Inc., SAN FRANCISCO, CA (US)

(21) Appl. No.: 19/402,917

(22) Filed: Nov. 26, 2025

(30) Foreign Application Priority Data
Apr. 21, 2025 (CN) 202520753117.0

(51) Int. Cl. H01R 13/52; H01R 13/506

(52) U.S. Cl. CPC H01R 13/5213; H01R 13/506

(57) ABSTRACT

A cap assembly and a flash drive are provided. The cap assembly includes a housing, a cap detachably connected to a front end or a rear end of the housing; and a support frame including a first end and a second end. The first end of the support frame is fixedly connected to the cap, and the second end of the support frame is movably connected to the housing. the cap is configured to switch placement between the front end and the rear end of the housing via the support frame.

### CROSS-REFERENCE

The present disclosure is based upon and claims priority to Chinese Patent Application No. 202520753117.0, filed on Apr. 21, 2025, the entire contents of which are incorporated herein by reference for all purposes.

### TECHNICAL FIELD

The present disclosure relates to the field of mechanical structure design, and more particularly, to a cap assembly and a flash drive.

### BACKGROUND

A cap assembly is a component in which a cap is combined with other elements to form a device, with the cap typically serving to protect or seal the internal parts of the device. For example, a USB flash drive may include a cap assembly integrated with its housing to protect the USB interface, which is used to connect the drive to another device for data transmission. However, during repeated use of the prior USB flash drive, the cap needs to be frequently removed from the housing. With an increasing number of insertion and removal cycles, the connection between the cap and the housing may loosen, causing the cap to fall off easily and potentially get lost.

### SUMMARY

According to a first aspect of the present disclosure, some embodiments provide a cap assembly. The cap assembly includes: a housing; a cap, detachably connected to a front end or a rear end of the housing; and a support frame, comprising a first end and a second end; wherein the first end of the support frame is fixedly connected to the cap, and the second end of the support frame is movably connected to the housing, and wherein the cap is configured to switch placement between the front end and the rear end of the housing via the support frame.

According to a second aspect of the present disclosure, some embodiments provide a flash drive. The flash drive includes: a flip-type anti-fall cap assembly, including: a housing; a cap, detachably connected to a front end or a rear end of the housing; and a support frame, comprising a first end and a second end; wherein the front end of the housing is provided with an opening communicating with interior of the housing, the first end of the support frame is fixedly connected to the cap, and the second end of the support frame is movably connected to the housing, and the cap is configured to switch placement between the front end and the rear end of the housing via the support frame; and a circuit board, disposed inside the housing, and an end of the circuit board facing the opening is provided with a data interface.

### BRIEF DESCRIPTION OF THE DRAWINGS

FIG. 1 is an exploded view of a flash drive structure according to an embodiment of the present disclosure;

FIG. 2 is a schematic view showing the cap pulled open from the front end of the housing of the flash drive according to an embodiment of the present disclosure;

FIG. 3 is a schematic view showing the cap being flipped during use of the flash drive according to an embodiment of the present disclosure;

FIG. 4 is a schematic view showing the cap mounted on the rear end of the housing of the flash drive according to an embodiment of the present disclosure;

FIG. 5 is a front view of the flash drive structure according to an embodiment of the present disclosure;

FIG. 6 is a cross-sectional view taken along line A-A of the flash drive shown in FIG. 5 according to an embodiment of the present disclosure;

FIG. 7 is a structural diagram of the cap and support frame according to an embodiment of the present disclosure.

FIG. 8 is an exploded view of a flash drive structure according to another embodiment of the present disclosure;

FIG. 9 is a schematic view showing the cap pulled open from the front end of the housing of the flash drive according to another embodiment of the present disclosure;

FIG. 10 is a schematic view showing the cap being flipped during use of the flash drive according to another embodiment of the present disclosure;

FIG. 11 is a schematic view showing the cap mounted on the rear end of the housing of the flash drive according to another embodiment of the present disclosure;

FIG. 12 is a front view of the flash drive structure according to another embodiment of the present disclosure;

FIG. 13 is a cross-sectional view taken along line A-A of the flash drive shown in FIG. 5 according to another embodiment of the present disclosure;

FIG. 14 is a structural diagram of the cap and support frame according to an embodiment of another present disclosure.

### REFERENCE SIGNS

1. Housing; 101. Upper cover; 102. Lower cover; 103. Left sliding chute; 104. Right sliding chute; 2. Circuit board; 3. USB interface; 4. Cap; 5. Support frame; 501. Left connecting rod; 502. Right connecting rod; 503. Left clamping rod; 504. Right clamping rod; 6. Flat surface; 7. Buckle structure; 8. Auxiliary slot; 9. Indicator light; 51. first end; 52. second end; 53. connection section.

### DETAILED DESCRIPTION

In order to make technical solutions and advantages of the present disclosure clearer, implementations of the present disclosure will be further described in detail below with reference to the drawings.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of examples do not represent all implementations consistent with the disclosure. Instead, they are merely examples of apparatuses and methods consistent with aspects related to the disclosure as recited in the appended claims.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

In the description of the present disclosure, terms such as “center”, “upper”, “lower”, “left”, “right”, “vertical”, “horizontal”, “inner”, “outer”, etc., indicating directions or positional relationships, are based on the directions or positional relationships shown in the drawings, or are the customary placement directions or positional relationships when the product of the present disclosure is used. They are used only for convenience in describing the present disclosure and simplifying the description, and do not indicate or imply that the referred device or element must have a specific orientation, be constructed and operated in a specific orientation, and therefore cannot be construed as limiting the scope of the present disclosure. Furthermore, terms such as “first,” “second,” “third,” etc., are used only for distinguishing descriptions and should not be understood as indicating or implying relative importance. Terms such as “horizontal,” “vertical,” “suspended,” etc., do not require the components to be absolutely horizontal or suspended, but may be slightly inclined. For example, “horizontal” merely means that its direction is more horizontal relative to “vertical”, and does not mean that the structure must be completely horizontal, but can be slightly inclined.

In the description of the present disclosure, unless otherwise explicitly specified and defined, the terms “install”, “mount”, “interconnect”, “connect” should be constructed broadly. For example, it can be a fixed connection, a detachable connection, or an integral connection; it can be a mechanical connection, an electrical connection, or can be a direct connection, or an indirect connection through an intermediary. In the description of this application, directional terms such as “front, rear, up, down, left, right,” “transverse, vertical, perpendicular, horizontal,” and “top, bottom,” etc., generally refer to the directions or positional relationships based on the drawings. They are used only for the convenience of describing this application and simplifying the description. In the absence of contrary explanation, these directional terms do not indicate or imply that the device or element referred to must have a specific orientation or be constructed and operated in a specific orientation, and therefore should not be construed as limiting the scope of this application. The directional terms “inner, outer” refer to the inside and outside relative to the contour of the respective components themselves.

The following describes the preferred embodiments of the present disclosure in detail with reference to the drawings, so that the advantages and features of the present disclosure can be more easily understood by those skilled in the art, thereby defining the protection scope of the present disclosure more clearly and explicitly.

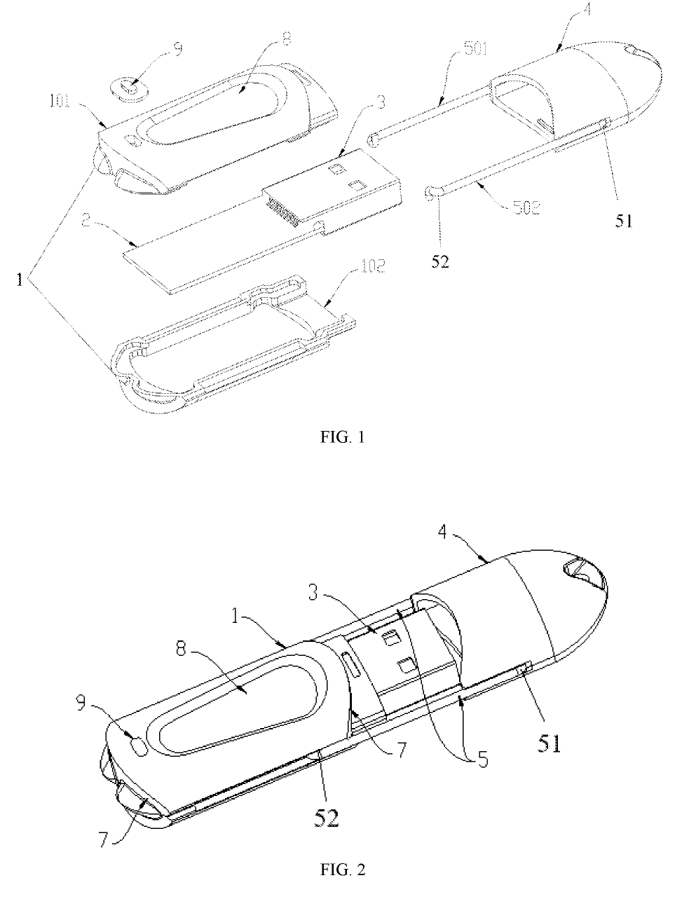

FIG. 1 is an exploded view of a flash drive structure according to an embodiment of the present disclosure. As shown in FIG. 1 the flash drive has a cap assembly. The cap assembly includes: a housing 1, a cap 4 detachably connectable to a front end or a rear end of the housing 1, and a support frame 5, The support frame 5 includes a first end 51 and a second end 52, the first end 51 is fixedly connected to the cap 4, and the second end 52 is movably connected to the housing 1; the cap 4 is configured to switch placement between the front end and the rear end of the housing 1 via the support frame 5. FIG. 8 shows an exploded view of a flash drive structure having a different ornamental design according to another embodiment of the present disclosure. Compared with FIG. 1, FIG. 8’s support frame 5 includes an connecting section 53 between the two first ends 51, forming a continuous looped structure that connects with the cap 4. In some embodiments of the present disclosure, the connection section 53 may be arc-shaped or may be embedded within the edge of the cap 4. The top surface and the protrusions at the end of FIG. 8’s housing 1 are also slightly reshaped. These variations provide an alternative ornamental design while maintaining the overall structural concept of the flash drive. It should be understood that the modifications to the ornamental design still fall within the protection scope of the present disclosure, and the specific ornamental details are not limited to those illustrated in the present disclosure.

The cap assembly enables an anti-fall function by maintaining a physical connection between the cap 4 and the housing 1 through the support frame 5 even when the cap 4 is detached from the data interface of the flash drive (for example, a USB interface). This prevents the cap 4 from being misplaced or dropped during use. Furthermore, the capability of switching the cap’s placement between the front end and the rear end of the housing 1 via the support frame 5 allows convenient storage of the cap 4 when the data interface is exposed, thereby improving portability and usability.

In some embodiments of the present disclosure, the cap 4 may be configured to slide along the housing 1 via the second end 52, so as to slip back and forth along the housing 1 to switch placement between the front end and the rear end of the housing 1 via the support frame 5. In some embodiments of the present disclosure, the cap 4 may be configured to flip back and forth for switching placement between the front end and the rear end of the housing 1 via the support frame 5.

The slide design allows the cap 4 to move smoothly along the housing 1, providing a simple and space-efficient way to protect or expose the data interface without completely detaching the cap 4, thereby reducing the risk of loss and improving ease of operation. The flip design enables the cap 4 to rotate relative to the housing 1, allowing quick switching between covered and uncovered states with minimal effort, enhancing user convenience and durability through repeated use. However, in some other embodiments, the cap 4 may switch placement between the front end and the rear end of the housing 1 through other mechanisms. For example, the cap 4 may be connected to the housing 1 via a telescopic linkage, allowing smooth and reliable movement between positions while maintaining firm attachment and ease of use. The connection mechanism between the cap 4 and the housing 1 is not limited to the embodiments of the present disclosure.

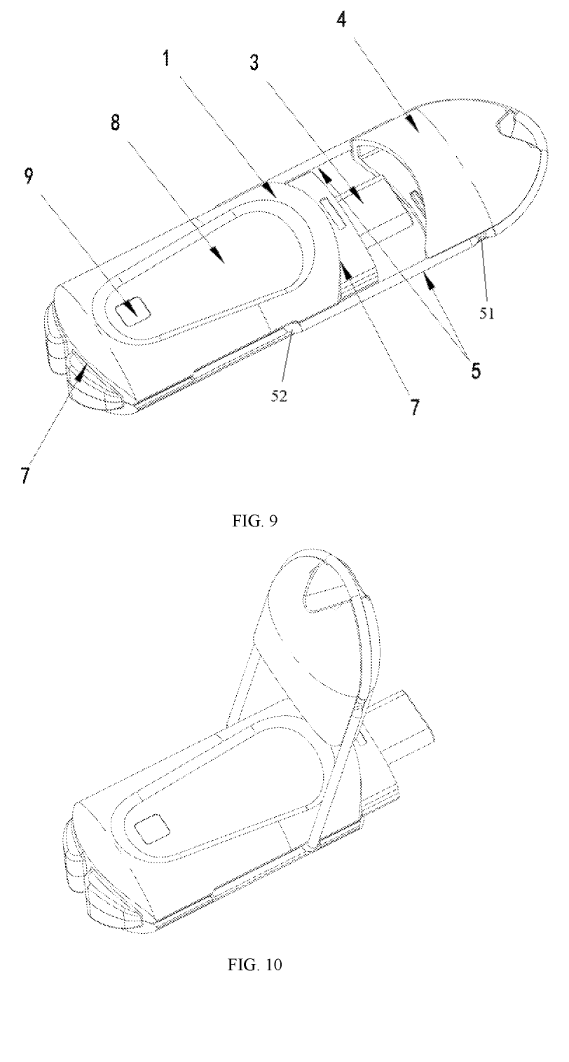

FIG. 2 is a schematic view showing the cap pulled open from the front end of the housing of the flash drive according to an embodiment of the present disclosure. FIG. 9 shows a similar schematic view provided by another embodiment of the present disclosure. As shown in FIGS. 2 and 9, the cap 4 is connected to the housing 1 through the support frame 5, in which the first end 51 of the support frame 5 is fixedly connected to the cap 4 and the second end 52 is movably connected to the housing 1. This structure allows the cap 4 to rotate relative to the housing 1 about the support frame 5, enabling the cap 4 to be pulled open and prepared for flipping while remaining attached to the housing 1.

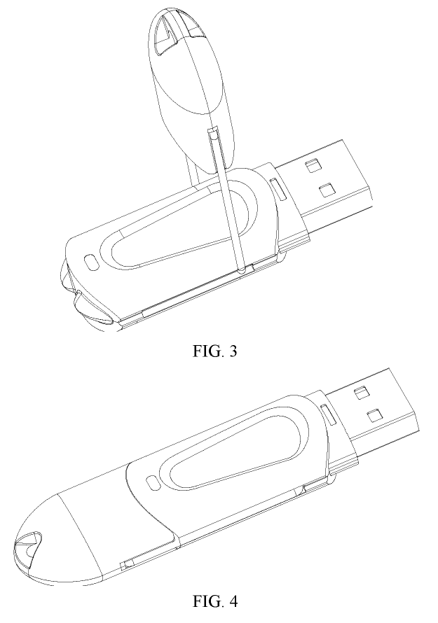

FIG. 3 is a schematic view showing the cap being flipped during use of the flash drive according to an embodiment of the present disclosure. FIG. 10 shows a similar schematic view provided by another embodiment of the present disclosure. As shown in FIGS. 3 and 10, the support frame 5 acts as a pivot link that guides the cap 4 to flip from the front end to the rear end of the housing 1. This flipping motion allows smooth and controlled movement of the cap 4 without detachment from the housing 1, thereby effectively preventing the cap 4 from falling or being lost during operation of the USB interface 3.

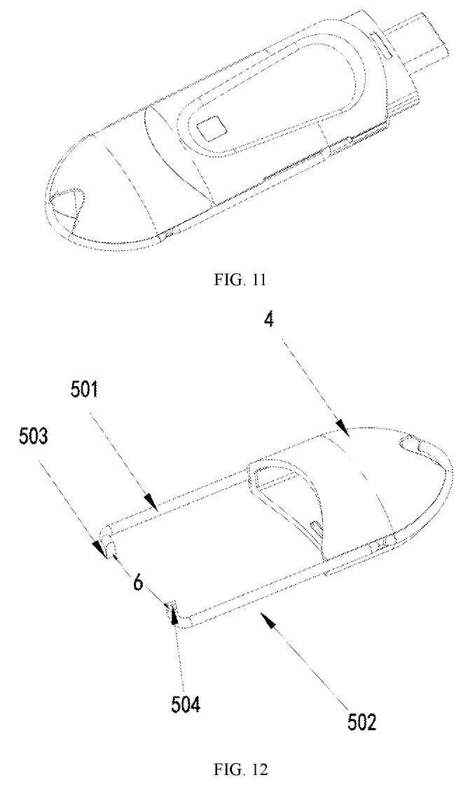

FIG. 4 is a schematic view showing the cap mounted on the rear end of the housing of the flash drive according to an embodiment of the present disclosure. FIG. 11 shows a similar schematic view provided by another embodiment of the present disclosure. As shown in FIGS. 4 and 11, after flipping, the cap 4 is stably positioned on the rear end of the housing 1 via the support frame 5, forming a compact and integrated appearance. This configuration not only achieves an anti-fall function by keeping the cap 4 securely connected to the housing 1 but also provides convenient temporary storage of the cap 4 during data transmission, enhancing both portability and user experience.

The cap assembly provided by the embodiments of the present disclosure allows the cap to be pulled and flipped via the support frame, enabling the cap to switch positions back and forth between the front and rear ends of the housing for installation. This flip-type cap design is not prone to falling off or being lost, and the operation is flexible and convenient, which effectively solves the problem of the cap being easily fall off and lost.

Although the cap assembly shown in the embodiments of FIGS. 1-4 and 8-11 is integrated in a flash drive, the cap assembly may also be applied to other devices, such as medical devices or communication devices, that require a cap to protect or seal internal components. The specific type of device to which the cap assembly is applied is not limited to the embodiments described in the present disclosure.

In some embodiments of the present disclosure, a front end of the housing 1 may be provided with an opening communicating with the interior of the housing 1. The cap 4 may be detachably connected to both the front end and the rear end of the housing 1. In some embodiments of the present disclosure, a circuit board 2 (as shown in FIGS. 1 or 8) may be disposed inside the housing 1, one end of the circuit board 2 facing the opening being provided with a USB interface 3.

Although the flash drive shown in FIGS. 1–4 or 8-11 is provided with a USB interface 3, in other embodiments, the flash drive may adopt different types of data interfaces for data transmission, such as a Type-C interface or a Lightning interface. The specific interface type may be selected according to the device compatibility or application requirements and is not limited to the embodiments of the present disclosure.

Referring to FIGS. 1-2 or 8-9, in some embodiments of the present disclosure, the housing 1 may include an upper cover 101 disposed above the circuit board 2 and a lower cover 102 disposed below the circuit board 2. The upper cover 101 and the lower cover 102 are fixedly connected. The upper cover 101 and lower cover 102 together fix the circuit board 2, avoiding deformation or loosening due to unilateral pressure and ensuring even force distribution.

The fixed connection between the upper cover 101 and the lower cover 102 prevents the gap between the upper cover 101 and the lower cover 102 from widening and causing the support frame 5 to detach, and also prevents users from disassembling it themselves, which could affect the service life of the flash drive.

Specifically, the connection between the upper cover 101 and the lower cover 102 includes, but is not limited to, ultrasonic welding. Ultrasonic welding provides excellent sealing for the micro-structures at the joints of the flash drive, effectively preventing dust and moisture ingress. The strength of the welded area after material fusion is close to that of the base material, and the resistance to dropping and vibration is better than traditional adhesive bonding. Ultrasonic welding avoids adhesive overflow contaminating internal circuits or the appearance. Ultrasonic welding does not require waiting for curing time and allows proceeding directly to the next process. Ultrasonic welding is typically completed within 0.1 to 1 second, much faster than adhesive bonding or other fixation methods, and has lower material costs, making it suitable for mass production.

In some other embodiments, the upper cover 101 and the lower cover 102 may be connected by other fixation methods, such as snap-fit engagement, screw fastening, or adhesive bonding, depending on structural or manufacturing requirements, as long as the connection method can provide reliable mechanical strength and assembly convenience according to different design needs. The specific connection type between the upper cover 101 and the lower cover 102 is not limited to the embodiments of the present disclosure.

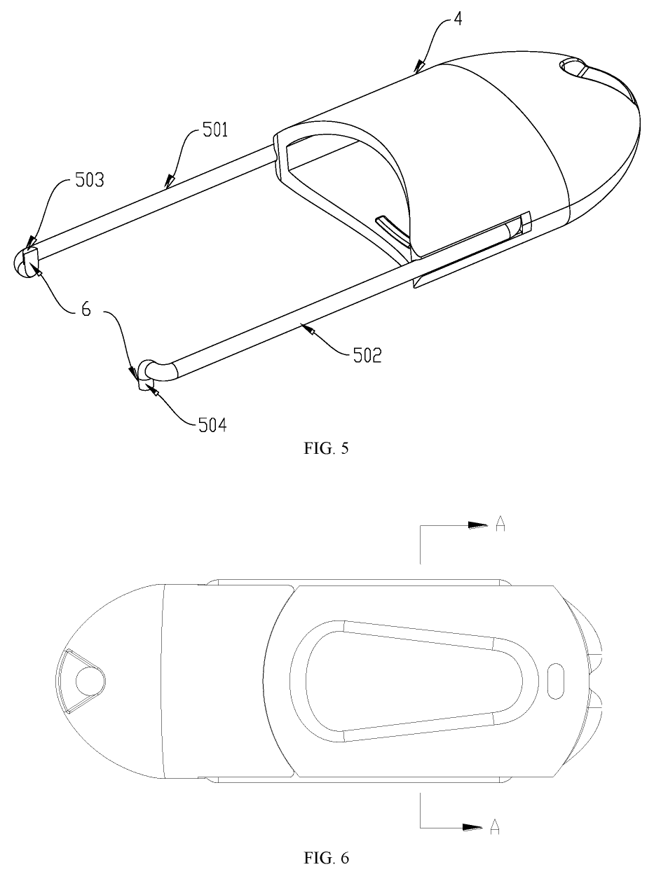

FIG. 5 is a front view of the flash drive structure according to an embodiment of the present disclosure. FIG. 6 is a cross-sectional view taken along line A-A of the flash drive shown in FIG. 5 according to an embodiment of the present disclosure. FIGS. 12 and 13 shows a font view and a cross-sectional view provided by another embodiment of the present disclosure. As shown in FIGS. 6 or 13, in some embodiments of the present disclosure, the support frame 5 may include a left connecting rod 501 and a right connecting rod 502; two sides of the housing 1 are respectively provided with a left sliding chute 103 and a right sliding chute 104, respectively adapted to the shapes of the left connecting rod 501 and the right connecting rod 502; the left connecting rod 501 and the right connecting rod 502 are slidably and snap-fitted with the left sliding chute 103 and the right sliding chute 104, respectively. The shape adaptation between the sliding chutes and the connecting rods ensures precise and controllable movement trajectory, avoiding deviation or jamming during sliding; the connecting rods 501/502, as moving parts, are embedded in the sliding chutes 103/104, saving external space and making the structure compact; the snap-fit installation requires no additional fasteners, reducing assembly complexity; the symmetrical layout on both sides balances the force, avoiding stress concentration on one side.

In some embodiments of the present disclosure, the cross-sections of both the left sliding chute 103 and the right sliding chute 104 may be T-shaped. The T-shaped chute structure effectively prevents the connecting rods from disengaging from the chute openings during movement; the T-shaped chute provides a larger contact area with the connecting rods inside, resulting in more even stress distribution and reduced local wear.

In other embodiments of the present disclosure, the cross-sections of the left sliding chute 103 and the right sliding chute 104 may be formed in other shapes, such as L-shaped, dovetail-shaped, or rectangular grooves, to achieve guiding and anti-detachment effects. Different chute shapes may be selected based on design space, material strength, or manufacturing considerations. The specific shape is not limited to the embodiments of the present disclosure.

Referring to FIGS. 3 or 10, in some embodiments of the present disclosure, mutually buckle structures 7 are provided between the cap 4 and the front end of the housing 1, and between the cap 4 and the rear end of the housing 1. The buckle structure 7 allows for assembly simply by pressing or snapping in, eliminating complex steps and allowing manual operation, making it convenient and efficient. The buckle structure 7 is typically integrated inside or at the edge of the cap 4 or the housing 1, not occupying additional space. The buckle structure 7 can be repeatedly assembled and disassembled without easily damaging the body of the cap 4 or the housing 1.

In other embodiments of the present disclosure, other types of connections may be used between the cap 4 and the front end of the housing 1, such as magnetic attachments or hinge mechanisms. The specific connection between the cap 4 and the front end of the housing 1 is not limited to the embodiments of the present disclosure.

Referring to FIGS. 1, 2, and 5 or 8, 9, and 12, in some embodiments of the present disclosure, the housing 1 may be provided with an auxiliary slot 8 into which a user’s finger can be placed for operation. The auxiliary slot 8 facilitates applying force with a user’s finger when the USB interface 3 is inserted into a computer, making the flash drive easier to plug and unplug.

In some other embodiments, alternative structural designs may be employed to facilitate user operation, such as a protrusion, a ring, or other features that a user can engage with a finger to insert or remove the USB interface 3 from a computer. The specific operation manner is not limited to the embodiments of the present disclosure.

In some embodiments of the present disclosure, the housing 1 may be provided with an indicator light 9, and the indicator light 9 is electrically connected to the circuit board 2. When the USB interface 3 is inserted into a device like a computer, the indicator light 9 illuminates upon successful insertion, making it easy to identify whether the insertion is proper. In FIG. 1, the indicator light 9 is positioned near the front end of the housing 1, adjacent to the USB connector area, whereas in FIG. 8, the indicator light 9 is relocated toward the upper middle portion of the housing 1, providing a different ornamental arrangement. The specific position of the indicator light 9 is not limited to the embodiments of the present disclosure.

In some other embodiments, other indication manners may be employed, such as sound signals, vibration, or color-changing surfaces. The specific indication manner is not limited to the embodiments of the present disclosure.

In some embodiments of the present disclosure, one end of the support frame 5 may be fixedly connected to the cap 4, and the other end is installed into the sliding chutes 103/104 on both sides of the housing 1. The side edges of both the upper cover 101 and the lower cover 102 may have installation slots. After the upper and lower installation slots are combined, the upper and lower installation slots form the T-shaped chutes on both sides. During use, first open the cap 4, then pull the cap 4 forward as shown in FIG. 3, then flip it 90° as shown in FIG. 4, then move it backward and flip it to 180°, and finally, as shown in FIG. 5, install the cap 4 onto the rear end of the housing 1.

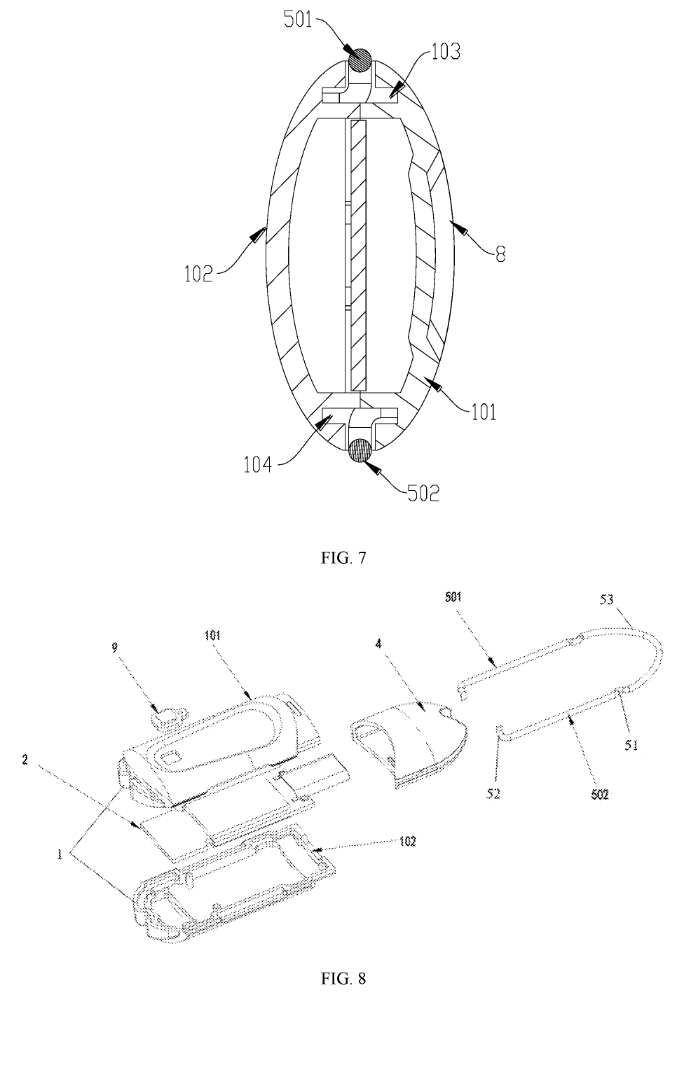

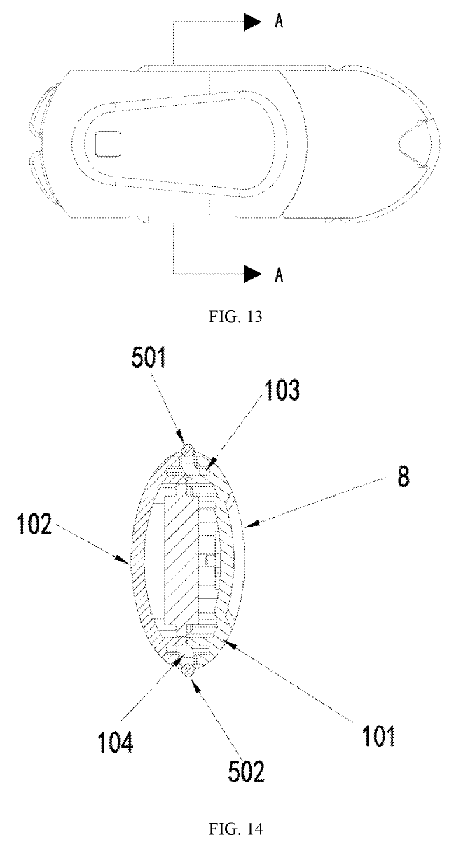

FIG. 7 is a structural diagram of the cap and support frame according to an embodiment of the present disclosure. FIG. 14 shows a structural diagram provided by another embodiment of the present disclosure. As shown in FIGS. 7 or 14, in some embodiments of the present disclosure, one end of the left connecting rod 501 connected to the left sliding chute 103 may be bent to form a left clamping rod 503, and one end of the right connecting rod 502 connected to the right sliding chute 104 may be bent to form a right clamping rod 504; the bent clamping rods 503/504 may be embedded into the inner groove of the T-shaped sliding chute, making them less prone to loosening even under reverse force, offering higher reliability and reduced maintenance needs.

In some embodiments of the present disclosure, the orientation of the left clamping rod 503 may be set opposite to the orientation of the right clamping rod 504. For example, when the left clamping rod 503 at the end of the left connecting rod 501 is bent upward, the right clamping rod 504 at the end of the right connecting rod 502 is bent downward, or vice versa. The design with opposing orientations of the two clamping rods 503/504 can simultaneously constrain the upper and lower edges of the sliding chute; the upper and lower clamping rods naturally guide the sliding chute to maintain a centered position during sliding, reducing jamming issues caused by assembly errors; it also prevents the clamping rods from sliding out of the chute when the cap 4 is flipped via the support frame 5.

The inner sides of both the left clamping rod 503 and the right clamping rod 504 are provided with flat surfaces 6 adapted to the chute walls of the left sliding chute 103 and the right sliding chute 104. The clamping rods 503/504 tends to rotate when moving within the sliding chute, while the flat surfaces 6 of the clamping rods 503/504 contact the chute walls, restricting the circumferential rotation of the rod and improving the controllability of the sliding direction.

In addition, the clamping rods 503/504 with the flat surface 6 cut on the inner side reduces radial space occupation, allowing adaptation to narrower sliding chutes 103/104.

In some other embodiments of the present disclosure, the inner walls of both the left sliding chute 103 and the right sliding chute 104 may be provided with detent protrusions. Designing protrusions to form “detent points” to make the clamping rods 503/504 overcome a certain resistance to pass over the protrusions during sliding, thereby stabilizing at specific positions (e.g., between protrusions), achieving multi-positioning and meeting the need for detents at different locations.

The above description is only for those skilled in the art to understand the technical solutions of the present disclosure, and is not intended to limit the present disclosure. Any modifications, equivalent replacements, improvements, etc. made within the spirit and principles of the present disclosure shall be included in the protection scope of the present disclosure.

What is claimed is:

1. A cap assembly, comprising:
a housing having a front end and a rear end;
a cap detachably connected to the front end or the rear end of the housing; and
a support frame comprising a first end and a second end;
wherein the first end of the support frame is fixedly connected to the cap, and the second end of the support frame is movably connected to the housing, and
wherein the cap is configured to switch placement between the front end and the rear end of the housing via the support frame.

2. The cap assembly according to claim 1, wherein the cap is configured to slide along the housing via the second end.

3. The cap assembly according to claim 1, wherein the cap is configured to flip back and forth for switching placement between the front end and the rear end of the housing via the support frame.

4. The cap assembly according to claim 1, wherein the front end of the housing is provided with an opening communicating with interior of the housing.

5. The cap assembly according to claim 1, wherein the housing comprises:
an upper cover, disposed above a circuit board in the housing; and
a lower cover, disposed below the circuit board,
wherein the upper cover and the lower cover are fixedly connected.

6. The cap assembly according to claim 1, wherein the support frame further comprises:
a left connecting rod and a right connecting rod,
wherein the housing comprises:
a left sliding chute and a right sliding chute, respectively adapted to the left connecting rod and the right connecting rod.

7. The cap assembly according to claim 6, wherein the left connecting rod and the right connecting rod are slidably and snap-fitted with the left sliding chute and the right sliding chute, respectively.

8. The cap assembly according to claim 6, wherein a cross-section of the left sliding chute or the right sliding chute is T-shaped.

9. The cap assembly according to claim 6, wherein an end of the left connecting rod connected to the left sliding chute is bent to form a left clamping rod, an end of the right connecting rod connected to the right sliding chute is bent to form a right clamping rod.

10. The cap assembly according to claim 9, an orientation of the left clamping rod is set opposite to an orientation of the right clamping rod.

11. The cap assembly according to claim 9, wherein an inner side of the left clamping rod is provided with a flat surface adapted to a chute wall of the left sliding chute; or
an inner side of the right clamping rod is provided with a flat surface adapted to a chute wall of the right sliding chute.

12. The cap assembly according to claim 1, further comprising a mutually buckle structure disposed between the cap and the front end of the housing, or between the cap and the rear end of the housing.

13. The cap assembly according to claim 6, wherein either an inner wall of the left sliding chute or an inner wall of the right sliding chute comprises a detent protrusion.

14. The cap assembly according to claim 1, wherein the housing is provided with an auxiliary slot for a user’s finger to be placed for operation.

15. The cap assembly according to claim 1, wherein the housing is provided with an indicator light, and the indicator light is electrically connected to a circuit board in the housing.

16. A flash drive, comprising:
a flip-type anti-fall cap assembly, comprising:
a housing having a front end and a rear end;
a cap detachably connected to the front end or the rear end of the housing; and
a support frame, comprising a first end and a second end;
wherein the front end of the housing is provided with an opening communicating with interior of the housing, the first end of the support frame is fixedly connected to the cap, and the second end of the support frame is movably connected to the housing, and the cap is configured to switch placement between the front end and the rear end of the housing via the support frame; and
a circuit board, disposed inside the housing, and an end of the circuit board facing the opening is provided with a data interface.

17. The flash drive according to claim 16, wherein the cap is configured to slide along the housing via the second end; or
the cap is configured to flip back and forth for switching placement between the front end and the rear end of the housing via the support frame.

18. The flash drive according to claim 16, wherein the support frame further comprises:
a left connecting rod and a right connecting rod,
wherein the housing comprises:
a left sliding chute and a right sliding chute, respectively adapted to the left connecting rod and the right connecting rod.

19. The flash drive according to claim 18, wherein an end of the left connecting rod connected to the left sliding chute is bent to form a left clamping rod, an end of the right connecting rod connected to the right sliding chute is bent to form a right clamping rod.

20. The flash drive according to claim 19, wherein an orientation of the left clamping rod is set opposite to an orientation of the right clamping rod; or
an inner side of the left clamping rod is provided with a flat surface adapted to a chute wall of the left sliding chute; or an inner side of the right clamping rod is provided with a flat surface adapted to a chute wall of the right sliding chute.
